(19) United States
(12) Patent Application Publication
(10) Pub. No.: US 2014/0035909 A1
(43) Pub. Date: Feb. 6, 2014

(54) SYSTEMS AND METHODS FOR GENERATING A THREE-DIMENSIONAL SHAPE FROM STEREO COLOR IMAGES

(71) Applicants: Michael Abramoff, University Heights, IA (US); Li Tang, Iowa City, IA (US)

(72) Inventors: Michael Abramoff, University Heights, IA (US); Li Tang, Iowa City, IA (US)

(73) Assignee: UNIVERSITY OF IOWA RESEARCH FOUNDATION, IOWA CITY, IA (US)

(21) Appl. No.: 13/980,804

(22) PCT Filed: Jan. 20, 2012
(86) PCT No.: PCT/US12/22115

§ 371 Date: Oct. 23, 2013

Related U.S. Application Data
(60) Provisional application No. 61/434,647, filed on Jan. 20, 2011.

(51) Int. Cl. G06T 15/00

(52) U.S. Cl. CPC G06T 15/00
USPC 345/419

(57) ABSTRACT

This disclosure presents systems and methods for determining the three-dimensional shape of an object. A first image and a second image are transformed into scale space. A disparity map is generated from the first and second images at a coarse scale. The first and second images are then transformed into a finer scale, and the former disparity map is upgraded into a next finer scale. The three-dimensional shape of the object is determined from the evolution of disparity maps in scale space.

### RELATED APPLICATIONS

This application claims priority to U.S. Provisional Application No. 61/434,647, filed on Jan. 20, 2011, the disclosure of which is incorporated herein in its entirety.

### BACKGROUND

Identifying depth of an object from multiple images of that object has been a challenging problem in computer vision for decades. Generally, the process involves the estimation of 3D shape or depth differences using two images of the same scene from slightly different angles. By finding the relative differences between one or more corresponding regions in the two images, the shape of the object can be estimated. Finding corresponding regions can be difficult, however, and can be made more difficult by issues inherent in using multiple images of the same object.

For example, a change of viewing angle will cause a shift in perceived (specular) reflection and hue of the surface if the illumination source is not at infinity or the surface does not exhibit Lambertian reflectance. Also, focus and defocus may occur in different planes at different viewing angles, if depth of field (DOF) is not unlimited. Further, a change of viewing angle may cause geometric image distortion or the effect of perspective foreshortening, if the imaging plane is not at infinity. In addition, a change of viewing angle or temporal change may also change geometry and reflectance of the surfaces, if the images are not obtained simultaneously, but instead sequentially.

Consequently, there is a need in the art for systems and methods of identifying the three-dimensional shape of an object from multiple images that can overcome these problems.

### SUMMARY

In one aspect, this disclosure relates to a method for determining the three-dimensional shape of an object. The three dimensional shape can be determined by generating scale-space representations of first and second images of the object. A disparity map describing the differences between the first and second images of the object is generated. The disparity map is then transformed into the second (for example, next finer) scale. By generating feature vectors, and by identifying matching feature vectors between the first and second images, correspondences can be identified. The correspondences represent depth of the object, and from these correspondences, a topology of the object can be created from the disparity map. The first image can then be wrapped around the topology to create a three-dimensional representation of the object.

### BRIEF DESCRIPTION OF THE DRAWINGS

FIG. 1 is a block diagram illustrating an exemplary operating environment for performing the disclosed methods;

FIG. 2 is a block diagram describing a system for determining the three-dimensional shape of an object according to an exemplary embodiment;

FIG. 3 is a flow chart describing a method for determining the three-dimensional shape of an object according to an exemplary embodiment;

FIG. 4 is a flow chart depicting a method for determining the three-dimensional shape of the object from disparity maps according to an exemplary embodiment;

FIG. 5 is an illustrative example of certain results from an exemplary embodiment; and

FIG. 6 is an illustrative example of the results of using conventional methods of creating a topography from images based on disparity maps.

### DETAILED DESCRIPTION

This disclosure describes a coarse-to-fine stereo matching method for stereo images that may not satisfy the brightness and constancy assumptions required by conventional approaches. The systems and methods described herein can operate on a wide variety of images of an object, including those that have weakly textured and out-of-focus regions. As described herein, a multi-scale approach is used to identify matching features between multiple images. Multi-scale pixel vectors are generated for each image by encoding the intensity of the reference pixel as well as its context, such as, by way of example only, the intensity variations relative to its surroundings and information collected from its neighborhood. These multi-scale pixel vectors are then matched to one another, such that estimates of the depth of the object are coherent both with respect to the source images, as well as the various scales at which the source images are analyzed. This approach can overcome difficulties presented by, for example, radiometric differences, de-calibration, limited illumination, noise, and low contrast or density of features.

Deconstructing and analyzing the images over various scales is analogous in some ways to the way the human visual system is believed to function. Studies show that rapid, coarse percepts are refined over time in stereoscopic depth perception in the visual cortex. It is easier for a person to associate a pair of matching regions from a global view where there are more prominent landmarks associated with the object. Similarly for computers, by analyzing images at a number of scales, additional depth features that may not present themselves at a more coarse scale can be identified at a finer scale. These features can then be correlated both among varying scales and different images to produce a three-dimensional representation of an object.

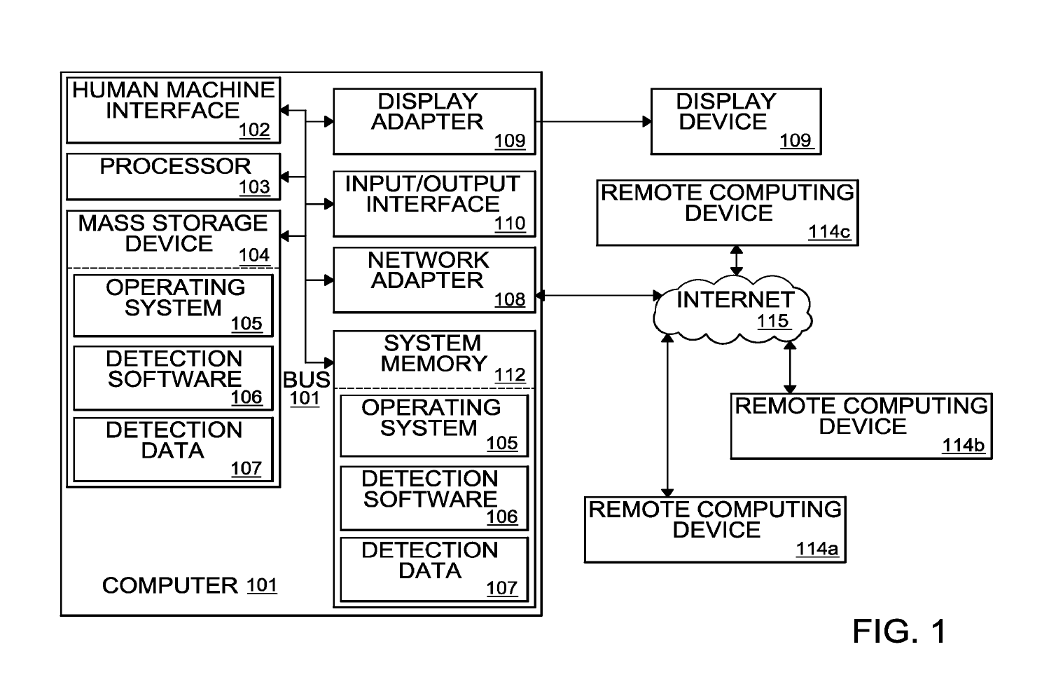

Turning now to the figures, FIG. 1 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the system and method comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 101. The components of the computer 101 can comprise, but are not limited to, one or more processors or processing units 103, a system memory 112, and a system bus 113 that couples various system components including the processor 103 to the system memory 112. In the case of multiple processing units 103, the system can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the processor 103, a mass storage device 104, an operating system 105, image processing software 106, image data 107, a network adapter 108, system memory 112, an Input/Output Interface 110, a display adapter 109, a display device 111, and a human machine interface 102, can be contained within one or more remote computing devices 114a,b,c at physically separate locations, connected through buses of this form, in effect implementing a fully distributed system.

The computer 101 typically comprises a variety of computer readable media. Exemplary readable media can be any available media that is accessible by the computer 101 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as image data 107 and/or program modules such as operating system 105 and image processing software 106 that are immediately accessible to and/or are presently operated on by the processing unit 103.

In another aspect, the computer 101 can also comprise other removable/non-removable, volatile/non-volatile computer storage media. By way of example, FIG. 1 illustrates a mass storage device 104 which can provide non-volatile storage of computer code, computer readable instructions, data structures, program modules, and other data for the computer 101. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and image processing software 106. Each of the operating system 105 and image processing software 106 (or some combination thereof) can comprise elements of the programming and the image processing software 106. Image data 107 can also be stored on the mass storage device 104. Image data 107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 101 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

In yet another aspect, a display device 111 can also be connected to the system bus 113 via an interface, such as a display adapter 109. It is contemplated that the computer 101 can have more than one display adapter 109 and the computer 101 can have more than one display device 111. For example, a display device can be a monitor, an LCD (Liquid Crystal Display), or a projector. In addition to the display device 111, other output peripheral devices can comprise components such as speakers (not shown) and a printer (not shown) which can be connected to the computer 101 via Input/Output Interface 110. Any step and/or result of the methods can be output in any form to an output device. Such output can be any form of visual representation, including, but not limited to, textual, graphical, animation, audio, tactile, and the like.

The computer 101 can operate in a networked environment using logical connections to one or more remote computing devices 114a,b,c. By way of example, a remote computing device can be a personal computer, portable computer, a server, a router, a network computer, a peer device or other common network node, and so on. Logical connections between the computer 101 and a remote computing device 114a,b,c can be made via a local area network (LAN) and a general wide area network (WAN). Such network connections can be through a network adapter 108. A network adapter 108 can be implemented in both wired and wireless environments. Such networking environments are conventional and commonplace in offices, enterprise-wide computer networks, intranets, and the Internet 115.

For purposes of illustration, application programs and other executable program components such as the operating system 105 are illustrated herein as discrete blocks, although it is recognized that such programs and components reside at various times in different storage components of the computing device 101, and are executed by the data processor(s) of the computer. An implementation of image processing software 106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

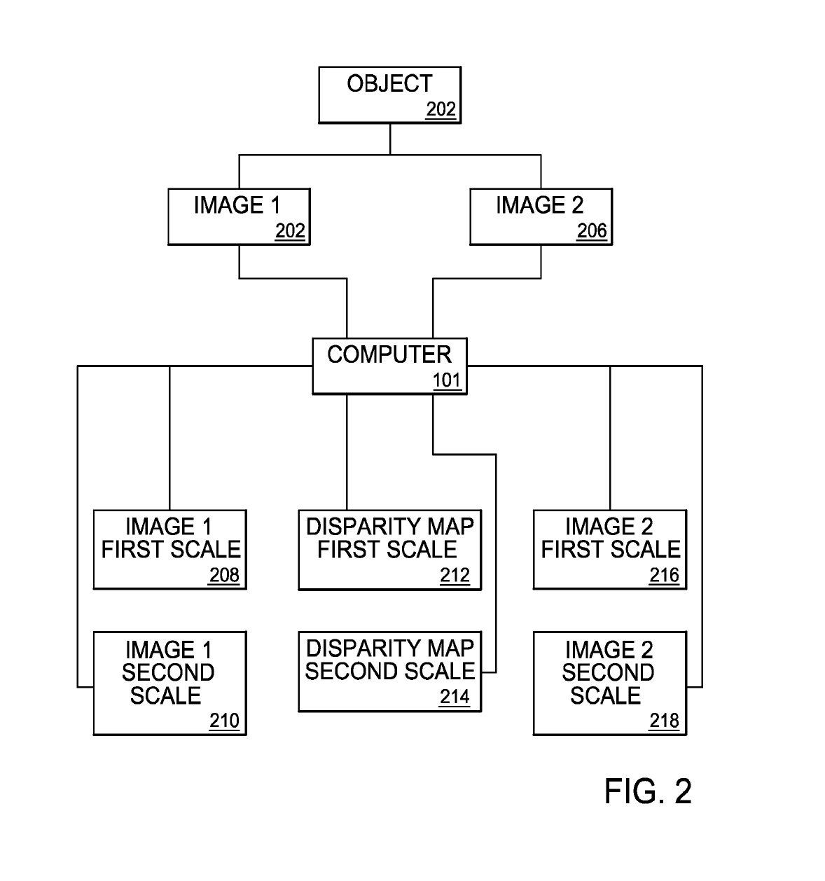

FIG. 2 is a block diagram describing a system for determining the three-dimensional shape of an object 202 according to an exemplary embodiment. The object 202 can be any three dimensional object, scene, display, or other item that is capable of being photographed or imaged in two dimensions. At least a first image 204 and a second image 206 of the object 202 are created. A computer, such as the computer described with respect to FIG. 1 that includes a processor 103 then receives the first and second images 204, 206. The processor 103 is configured to perform a number of processing steps on the first image 204 and the second image 206, which will be described in greater detail below.

The processor 101 creates scale-space representations 208,210 of the first image 204 and 216,218 of the second image 206. Scale space consists of image evolutions with the scale as the third dimension. In an exemplary embodiment, a scale-space representation is a representation of the image at a given scale sₖ. A scale-space representation on a coarse scale may include less information, but may allow for simpler analysis of gross features of the object 202. A scale-space representation on a fine scale, on the other hand, may include more information about the detailed features but may produce matching ambiguities.

In an exemplary embodiment, to extract stereo pairs at different scales, a Gaussian function is used as the scale space kernel. Image I₁(x, y) at scale sₖ is produced from a convolution with the variable-scale Gaussian kernel G(x, y, σₖ), followed by a bicubic interpolation to reduce its dimension. The following exemplary formula may be used to carry out the calculation:

$$\begin{matrix}\begin{matrix}{I}_{i} ( x , y , {s}_{k} ) = {φ}_{k} [ G ( x , y , {σ}_{k} ) * {I}_{i} ( x , y ) , {s}_{k} ] \\ = {φ}_{k} [ ( \frac{1}{2 π {σ}_{k}^{2}} {e}^{- ( {x}^{2} + {y}^{2} ) / 2 {σ}_{k}^{2}} ) * {I}_{i} ( x , y ) , {s}_{k} ]\end{matrix} & \\ i = 1 , 2 ; x = 1 , … , {M}_{k} ; y = 1 , … , {N}_{k} , & \end{matrix}$$

where symbol * represents convolution and φₖ(I, sₖ) is the bicubic interpolation used to down-scale image I. The scales of neighboring images increase by a factor of r with a down-scaling factor: sₖ=r^{k}, r>1, k=K, K−1, . . . , 1, 0. The resolution along the scale dimension can be increased with a smaller base factor r. Parameter K is the first scale index which down-scales the original stereo pair to a dimension of no larger than Mₘᵢₙ×Nₘᵢₙ pixels. The standard deviation σₖ of the variable-scale Gaussian kernel is proportional to the scale index k: σₖ=ck, where c=1.2 is a constant related to the resolution along the scale dimension. This process can be used to create scale-space representations at any chosen scale. In an exemplary embodiment, the computer creates scale-space representations 208,210 of the first image 204 and 216,218 of the second image 206 at scale sₖ and sₖ₋₁. In an exemplary embodiment, the second scale sₖ₋₁ is a finer scale than the first scale sₖ.

The processor 103 then creates a disparity map 212 from the scale-space representations. In an exemplary embodiment, a disparity map 212 represents differences between corresponding areas in the two images. The disparity map 212 also includes depth information about the object 202 in the images. The disparity map 212 is then upscaled to the second scale sₖ₋₁. The upscaled disparity map 214 represents the depth features at the second scale.

In an exemplary embodiment, the process of scaling the images and upscaling the disparity map can be repeated for many iterations. In this embodiment, at each scale, certain features are selected as the salient ones with a simplified and specified description. After the iterations at various scale have been completed, the collection of disparity maps will represent the depth features of the object 202. The combined disparity maps at various scales will represent a topology of the three-dimensional object 202. One of the original images can be wrapped to the topology to provide a three-dimensional representation of the object 202. In another exemplary embodiment, two disparity maps are created at each scale—one using the first image 204 as the reference, the second using the second image 206 as the reference. At each scale, a pair of disparity maps can be fused together to provide a more accurate topology of the object 202.

In an exemplary embodiment, the upscaled disparity map is created using the following function:

$${D}_{0} ( x , y , {s}_{k - 1} ) = {φ}_{k}^{′} [ r \cdot ( μ + \frac{{σ}^{2} - {\overline{σ}}^{2}}{{σ}^{2}} ( D ( x , y , {s}_{k} ) - μ ) ) ] \\ x = 1 , … , {M}_{k - 1} ; y = 1 , … , {N}_{k - 1} , \qquad ( 3 )$$

where σ² is the average of all local estimated variances. φ′ₖ is the bicubic interpolation used to upscale the disparity map from sₖ to sₖ₋₁. Noise in the disparity map may be smoothed by applying, for example, a low-pass filter such as a Weiner filter that estimates the local mean μ and variance σ² within a neighborhood of each pixel.

In an exemplary embodiment, the representation D₀(x, y, sₖ₋₁) can provide globally coherent search directions for the next finer scale sₖ₋₁. This multiscale representation provides a comprehensive description of the disparity map in terms of point evolution paths. Constraints enforced by landmarks guide finer searches for correspondences towards correct directions along those paths while the small additive noise is filtered out. The Wiener filter performs smoothing adaptively according to the local disparity variance. Therefore depth edges in the disparity map are preserved where the variance is large and little smoothing is performed.

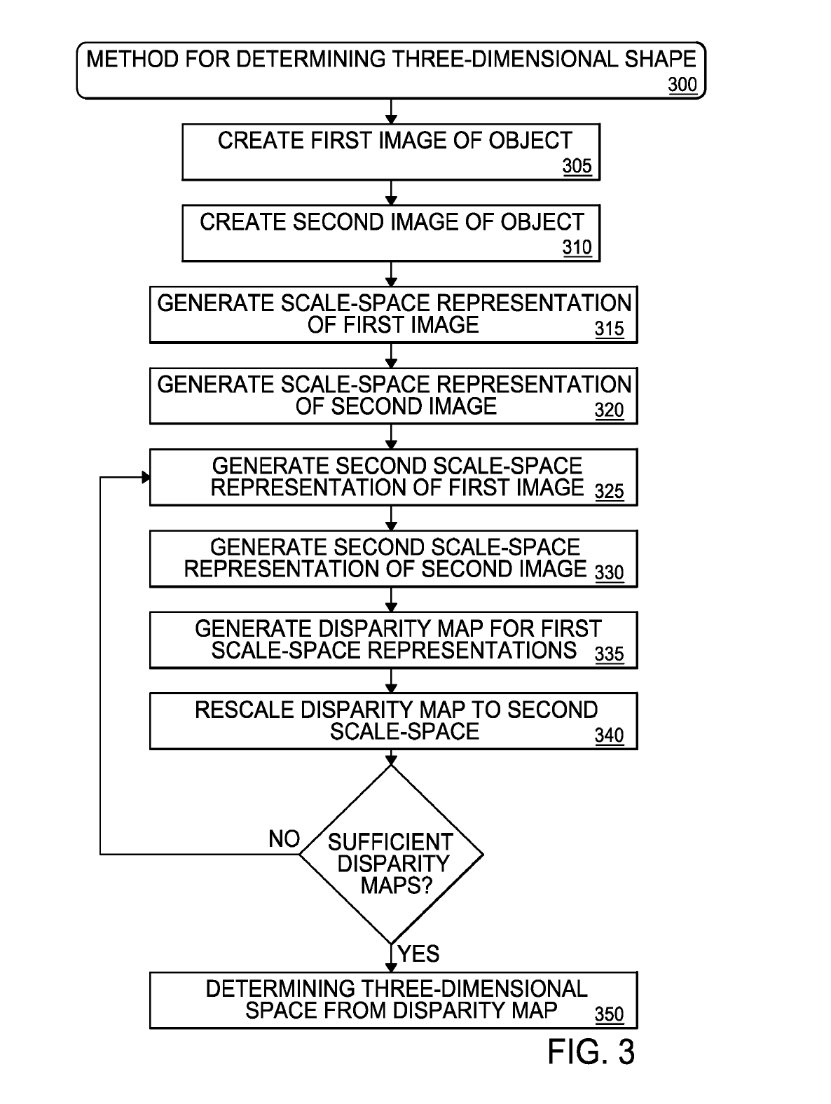

FIG. 3 is a flow chart describing a method for determining the three-dimensional shape of an object 202 according to an exemplary embodiment. FIG. 3 will be discussed with respect to FIG. 1 and FIG. 2. In steps 305 and 310, first and second images 204,206 of the object 202 are generated. In an exemplary embodiment, the images are created from different perspectives. The images need not be generated simultaneously, nor must the object 202 exhibit Lambertian reflectance. Further, parts of either image may be blurred, and intensity edges of the object 202 need not coincide with depth edges. In short, the images do not need to be identical in every respect other than perspective. The images can be captured in any way, such as with a simple digital camera, scanned from printed photographs, or through other image capture techniques that will be well known to one of ordinary skill in the art.

The method then proceeds to steps 315 and 320, wherein scale-space representations of the first and second images 204,206 are generated at a scale sₖ. In an exemplary embodiment, the scale-space representations are generated as described above with respect to FIG. 2. The method then proceeds to steps 325 and 330, wherein scale-space representations of the first and second images 204,206 are generated at a second scale sₖ₋₁. In an exemplary embodiment, the second scale is finer than the first scale.

The method then proceeds to step 335, wherein a disparity map is created between the first and second images 315, 320 at one scale. In the event that a disparity map has already been created between the first and second images of a certain scale, an additional disparity map need not be created at this scale. In an exemplary embodiment, the disparity map created in step 335 will be at scale sₖ. In the exemplary embodiment, the disparity map is generated as described above with respect to FIG. 2. The method then proceeds to step 340, wherein a upscaled disparity map is generated at scale sₖ₋₁ and upgraded in accordance with the first and second images 325,330 at the same scale sₖ₋₁. In an exemplary embodiment, the scaled disparity map is generated as described above with respect to FIG. 2.

The method then proceeds to decision step 345, wherein it is determined whether disparity maps have been generated with sufficient resolution. By way of example, finer disparity maps may continue to be generated until it reaches the scale where the original first and second images 305,310 were created. If the decision in step 345 is negative, the NO branch is followed to step 325, wherein additional scale levels are generated. If the decision in step 345 is affirmative, the YES branch is followed to step 350, wherein the three dimensional shape of the object 202 is determined from the disparity maps.

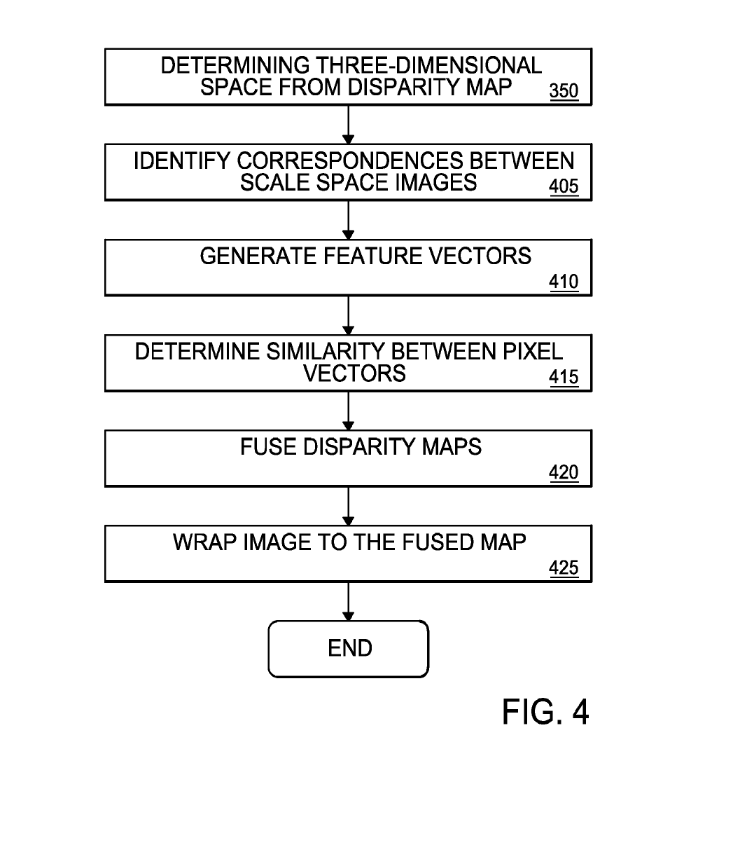

FIG. 4 is a flow chart depicting a method for determining the three-dimensional shape of the object 202 in terms of disparity maps according to an exemplary embodiment. FIG. 4 will be discussed with respect to FIG. 1, FIG. 2, and FIG. 3. In step 405, correspondences between the scale-space representations are identified. To identify correct correspondences and represent them as disparity maps, we specify the disparity range of a potential match, which is closely related to the computational complexity and desired accuracy. Under the multi-scale framework, image structures are embedded along the scale dimension hierarchically. Constraints enforced by global landmarks are passed to finer

scales as well located candidate matches in a coarse-to-fine fashion.

In an exemplary embodiment, as locations of point S evolve continuously across scales, the link through them, represented as L_{S}(sₖ): {I_{S}(sₖ); kε[0,K]}, can be predicted by the drift velocity, a first order estimate of the change in spatial coordinates for a change in scale level. The drift velocity is related with the local geometry, such as the image gradient. When the resolution along the scale dimension is sufficiently high, the maximum drift between neighboring scales can be approximated as a small constant for simplicity.

For example, let the number of scale levels be Nₛ with base factor r, the maximum scale factor fₘₐₓ=r^{Ns}. That is to say, a single pixel at the first scale accounts for a disparity drift of at least ±fₘₐₓ pixels at the finest scale in all directions. At a given scale Sₖ, given a pixel (x, y) in the reference image I₁(sₖ) with disparity map D₀(x, y, sₖ) passed from the previous scale sₖ₊₁, locations of candidate correspondences S(x, y, sₖ) in equally scaled matching image I₂(sₖ) can be predicted according to the drift velocity as:

S(x,y,sₖ)ε{I₂(x+D₀(x,y,sₖ)+Δ,y,sₖ)}, (x,y)εI₁(x,y,sₖ); Δε[−δ,δ].

In an exemplary embodiment, a constant range of 1.5 for drift velocity δ may be used. The description of disparity D₀(x, y, sₖ) can guide the correspondence search towards the right directions along the point evolution path L, as well as recording the deformation information in order to achieve a match up to the current scale sₖ. Given this description of the way image I₁(sₖ₊₁) is transformed to image I₂(sₖ₊₁) with deformation f(sₖ₊₁): I₁(sₖ₊₁)→I₂(sₖ₊₁), matching at scale sₖ is easier and more reliable. This is how the correspondence search is regularized and propagated in scale space.

In an exemplary embodiment, the matching process assigns one disparity value to each pixel within the disparity range for a given image pair. The multi-scale approach distributes the task to different scales, which can significantly reduce the matching ambiguity at each scale. This can be useful, for example, for noisy stereo pairs with low texture density.

The method then proceeds to step 410, wherein feature vectors are generated. A feature vector (or pixel feature vector) encodes the intensities, gradient magnitudes and continuous orientations within the support window of a center pixel with their spatial location in scale space. The intensity component of the pixel feature vector consists of the intensities within the support window, as intensities are closely correlated between stereo pairs from the same modality. The gradient component consists of the magnitude and continuous orientation of the gradients around the center pixel. The gradient magnitude is robust to shifts of the intensity while the gradient orientation is invariant to the scaling of the intensity, which exist in stereo pairs with radiometric differences.

In an exemplary embodiment, given pixel (x, y) in image I, its gradient magnitude m(x, y) and gradient orientation Θ(x, y) of intensity can be computed as follows:

$$m ( x , y ) = \sqrt{{[ I ( x + 1 , y ) - I ( x - 1 , y ) ]}^{2} + {[ I ( x , y + 1 ) - I ( x , y - 1 ) ]}^{2}} , \\ θ ( x , y ) = {tan}^{- 1} [ \frac{I ( x , y + 1 ) - I ( x , y - 1 )}{I ( x + 1 , y ) - I ( x - 1 , y )} ] . \qquad ( 6 )$$

The gradient component of the pixel feature vector F_{g} is the gradient angle Θ weighted by the gradient magnitude m, which is essentially a compromise between the dimension and the discriminability:

F_{g}(x₀,y₀,sₖ)=[m(x₀−n₂,y₀−n₂,sₖ)×θ(x₀−n₂,y₀−n₂,sₖ), . . . m(x₀+n₂,y₀+n₂,sₖ)×θ(x₀+n₂,y₀+n₂,sₖ)], (7)

The multi-scale pixel vector feature F of pixel (x₀; y₀) is represented as the concatenation of both components:

F(x₀,y₀,sₖ)=[Fₛ(x₀,y₀,sₖ)F_{g}(x₀,y₀,sₖ)], (x₀,yⱼ,sₖ)εN(x₀,y₀,sₖ),

Where the size of support window N(x₀, y₀, sₖ) is (2nᵢ+1)×(2nᵢ+1) pixels, where i=1, 2. For intensity component and gradient component of the pixel feature vector, different sizes of supports can be chosen by adjusting n₁ and n₂. In an exemplary embodiment, n₁=3 and n₂=4. In scale space, both intensity dissimilarity and the number of features or singularities of a given image decrease as the scale becomes coarser. By way of example, at coarse scales, some features may merge together and intensity differences between stereo pairs become less significant. In this instance, the intensity component of the pixel feature vector may become more reliable. Similarly, at finer scales, one feature may split into several adjacent features. In this instance, the gradient component may aid in accurate localization. Though locations of different structures may evolve differently across scales, singularity points are assumed to form approximately vertical paths in scale space. These can be located accurately with our scale invariant pixel feature vector. For regions with homogeneous intensity, the reliabilities of those paths are verified at coarse scales when there are some structures in the vicinity to interact with. This also explains why the matching ambiguity can be reduced by distributing it across scales. With active evolution of the very features in the matching process, the deep structure of the images is fully represented due to the nice continuous behavior of the pixel feature vector in scale space.

The method then proceeds to step 415, wherein the similarity between pairs of pixel vectors is determined (Identify Correspondences Between Scale Space Images). In an exemplary embodiment, this is done by establishing a matching score for the pair. The matching score is used to measure the degree of similarity between them and determine if the pair is a correct match.

In an exemplary embodiment, to determine the matching metric in scale space, deformations of the structure available up to scale sₖ₊₁ are encoded in the disparity description D₀(x, y, sₖ), which can be incorporated into a matching score based on disparity evolution in scale space. Specifically, those pixels with approximately the same drift tendency during disparity evolution as the center pixel (x₀, y₀) within its support window N(x₀, y₀, sₖ) provide more accurate supports with less geometric distortions. Hence they are emphasized even if they are spatially located far away from center pixel (x₀, y₀). This is performed by introducing an impact mask W(x₀, y₀, sₖ), which is associated with the pixel feature vector F(x₀, y₀, sₖ) in computing the matching score. In an exemplary embodiment, the impact mask can be calculated as follows:

W(x₀,y₀,sₖ)=exp[−α|D₀(x₀,y₀,sₖ)−D₀(x₀,y₀,sₖ)|], (x₀,y₀,sₖ)εN(x₀,y₀,sₖ). (10)

In this embodiment, Parameter α=1 adjusts the impact of pixel (x, y) according to its current disparity distance from pixel (x₀, y₀) when giving its support at scale sₖ. The matching score r₁ is then computed between pixel feature vectors F₁(x₀ y₀, sₖ) in the reference image I₁(x, y, sₖ) and one of the candidate correspondences F₂(x, y, sₖ) in the matching image I₂(x, y, sₖ) as:

$${r}_{1} ( {F}_{1} ( {x}_{0} , {y}_{0} , {s}_{k} ) , {F}_{2} ( x , y , {s}_{k} ) ) = \frac{{\sum }_{N} ( W \cdot {F}_{1} ( {x}_{0} , {y}_{0} , {s}_{k} ) - {\overline{F}}_{1} ) ( W \cdot {F}_{2} ( x , y , {s}_{k} ) - {\overline{F}}_{2} )}{\sqrt{\sum {( W \cdot {F}_{1} ( {x}_{0} , {y}_{0} , {s}_{k} ) - {\overline{F}}_{1} )}^{2} \sum {( W \cdot {F}_{2} ( x , y , {s}_{k} ) - {\overline{F}}_{2} )}^{2}}} \\ ( x , y , {s}_{k} ) ∈ S ( {x}_{0} , {y}_{0} , {s}_{k} ) , \qquad ( 11 )$$

where Fᵢ(bar) is the mean of the pixel feature vector after incorporating the deformation information available up to scale sₖ₊₁. The way that image I₁(sₖ₊₁) is transformed to image I₂(sₖ₊₁) is also expressed in the matching score through the impact mask W(x₀, y₀, sₖ) and propagated to the next finer scale.

In an exemplary embodiment, the support window is kept constant across scales, as its influence is handled automatically by the multiscale formulation. At coarse scales, the aggregation is performed within a large neighborhood comparative to the scale of the stereo pair. Therefore the initial representation of the disparity map is smooth and consistent. As the scale moves to finer levels, the same aggregation is performed within a small neighborhood comparative to the scale of the stereo pair. So the deep structure of the disparity map appears gradually during the evolution process with sharp depth edges preserved. There may be no absolutely “sharp” edges. It is a description relative to the scale of the underlying image. A sharp edge at one scale may appear smooth at another scale.

In an exemplary embodiment, the similarity between pixel vectors may also be determined among pixels in neighboring scales. This can help to account for out-of-focus blur, and, given reference image I₁(x, y, sₖ), a set of neighboring variable-scale Gaussian kernels {G(x, y, α_{k+Δk})} are applied to matching image I₂(x, y) as follows:

G(x,y,σ_{k+Δk})*I₂(x,y), Δkε[−ε,+ε].

The feature vector of pixel (x₀, y₀) is extracted in the reference image as F₁(x₀, y₀, sₖ) and in the neighboring scaled matching images as F₂(x, y, s). The point associated with the maximum matching score (x, y)* is taken as the correspondence for pixel (x₀, y₀), where subpixel accuracy is obtained by fitting a polynomial surface to matching scores evaluated at discrete locations within the search space of the reference pixel S(x₀, y₀, sₖ) with the scale as its third dimension:

(x,y)*arg max(r₁(F₁(x₀,y₀,sₖ),F₂(x,y,s))), (x,y,s)εS(x₀,y₀,sₖ).

This step measures similarities between pixel (x₀, y₀, sₖ) in reference image I₁ and candidate correspondences (x, y, s) in matching image I₂ in scale space. Due to the limited depth of field of the optical sensor, two equally scaled stereo images may actually have different scales with respect to structures of the object 202, which may cause inconsistent movements of the singularity points in scale space. Therefore, in an exemplary embodiment, when searching for correspondences, the best matched spatial location and the best matched scale are found jointly.

The method then proceeds to step 420, wherein the disparity maps are fused. To treat the stereo pair the same at each scale, both left image I₁(x, y, sₖ) and right image I₂(x, y, sₖ) are used as the reference in turn to get two disparity maps D₁(x, y, sₖ) and D₂(x, y, sₖ), which satisfy:

I₁₍₂₎(x,y,sₖ)=I₂₍₁₎(x+D₁₍₂₎(x,y,sₖ),y,sₖ), (x,y)εI₁₍₂₎(x,y)

As Dᵢ(x, y, sₖ), i=1, 2 has sub-pixel accuracy, for those evenly distributed pixels in the reference image, their correspondences in the matching image may fall in between of the sampled pixels. When the right image is used as the reference, correspondences in the left image are not distributed evenly in pixel coordinate. To fuse both disparity maps and produce one estimate relative to left image I₁(x, y, sₖ), a bicubic interpolation is applied to get a warped disparity map D′₂(x, y, sₖ) from D₂(x, y, sₖ), which satisfies:

I₁(x,y,sₖ)=I₂(x+D₂′(x,y,sₖ),y,sₖ), where D₂′(x+D₂′(x,y,sₖ),y,sₖ)=−D₂(x,y,sₖ).

The matching score r₂(x, y, sₖ) corresponding to D₂(x, y, sₖ) is warped to r′₂(x, y, sₖ) accordingly. Since both disparity maps D₁(x, y, sₖ) and D′₂(x, y, sₖ) represent disparity shifts relative to the left image at scale sₖ, they can be merged together to produce a fused disparity map D(x, y, sₖ) by selecting disparities with larger matching scores.

The method then turns to step 425, wherein the image is wrapped to the topology created by the disparity maps. In an exemplary embodiment, the first image 204 is used, although either the first 204 or the second image 206 may be used. The method then ends.

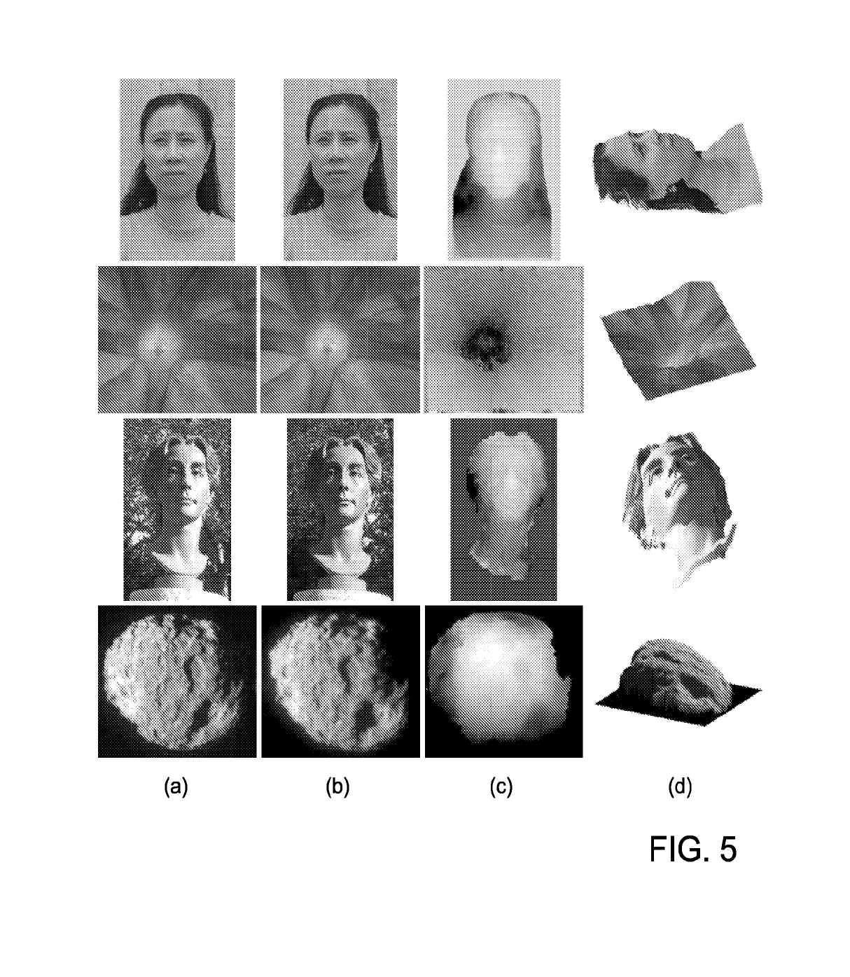

FIG. 5 is an illustrative example of certain results from an exemplary embodiment. FIG. 5 includes four different examples of the conversion of two images of an object 202 into a three-dimensional image. Column (a) is a first image of the object (taken from a slightly leftward perspective). Column (b) is a second image of the object (taken from a perspective slightly to the right of the image in column (a). Column (c) is a visual representation of the disparity map. In the picture in column (c), darker regions represent a greater distance from the camera. Finally, column (d) shows the image from column (a) wrapped around the topology shown in column (c). The image in column (d) has been rotated to better illustrate the various depths the algorithm was successfully able to identify. One of skill in the art would recognize that the images in column (d) show that the methods and systems for determining the three dimensional shape of an object disclosed herein are exceptional in identifying depth from the photographs in columns (a) and (b). Indeed, a close inspection of the first picture in column (d) illustrates the identification of subtle changes in depth, including, without limitation, wrinkles on a solid-colored shirt.

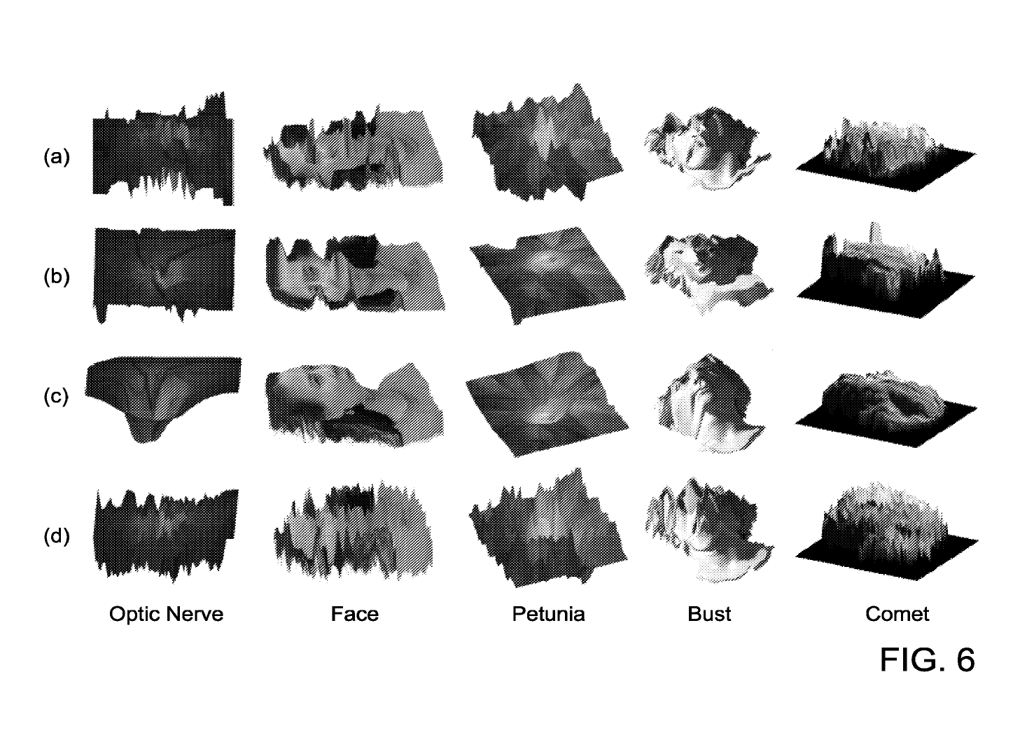

FIG. 6 is an illustrative example of the results of using conventional methods of creating a topography from images based on disparity maps. Row (a) represents the wrapping of images around a topography created using the technique described by Klaus et al. in “Segment-based stereomatching using belief propagation and a self-adapting dissimilarity measure” (ICPR 2006). Row (b) represents the wrapping of the same images around a topography created using the technique described by Yang et al. in “Stereo Matching with Color-Weighted Correlation, Hierarchical Belief Propagation, and Occlusion Handling” (IEEE Trans. Pattern Analysis and Machine Intelligence, vol. 31, no. 3, pp. 492-504, 2009). Row (c) represents the wrapping of the same images around a topography created using the technique described by Brox et al. in “High accuracy optical flow estimation based on a theory for warping” (European Conference on Computer Vision (ECCV), 2004). Row (d) represents the wrapping of the same images around a topography created using conventional correlation. As one of ordinary skill in the art would recognize, the results from the technique described herein are superior representations of the three-dimensional object as compared to these other conventional techniques.

The systems and methods described herein are intended to be merely exemplary techniques for determining the three-dimensional shape of an object from two-dimensional images. Although the description includes a number of exemplary formulae and techniques that can be used to carry out the disclosed systems and methods, one of ordinary skill in the art would recognize that these formulae and techniques are merely examples of one way the systems and methods might execute, and are not intended to be limiting. Instead, the invention is to be defined by the scope of the claims.

What is claimed is:

1. A method for determining the three-dimensional shape of an object, comprising:
generating a first scale-space representation of a first image of an object at a first scale;
generating a second scale-space representation of the first image at a second scale;
generating a first scale-space representation of a second image of an object at the first scale;
generating a second scale-space representation of the second image at the second scale;
generating a disparity map representing the differences between the first scale-space representation of the first image and the first scale-space representation of the second image;
rescaling the disparity map to the second scale; and
determining the three-dimensional shape of the object from the rescaled disparity map.

2. The method of claim 1, wherein the step of determining the three-dimensional shape of the object further comprises the step of identifying correspondences between the first scale-space representation of the first image and the first scale-space representation of the second image.

3. The method of claim 1, wherein the step of determining the three-dimensional shape of the object further comprises the step of generating feature vectors for correspondence identification.

4. The method of claim 3, wherein the feature vectors comprise at least one of the intensities, gradient magnitudes, and continuous orientations of a pixel.

5. The method of claim 3, further comprising the step of identifying best matched feature vectors associated with a pair of regions in the first and second images in scale space.

6. The method of claim 1, the step of determining the three-dimensional shape of the object further comprises the step of fusing a pair of disparity maps at each scale and creating a topography of the object.

7. The method of claim 1, the step of determining the three-dimensional shape of the object further comprises the step of wrapping one of the first image and the second image around topography encoded in the disparity map.

8. A system for determining the three-dimensional shape of an object, comprising:
a memory;
a processor configured to perform the steps of:
generating a first scale-space representation of a first image of an object at a first scale;
generating a second scale-space representation of the first image at a second scale;
generating a first scale-space representation of a second image of an object at the first scale;
generating a second scale-space representation of the second image at the second scale;
generating a disparity map representing the differences between the scale-space representation of the first image and the first scale-space representation of the second image;
rescaling the disparity map to the second scale; and
determining the three-dimensional shape of the object from the rescaled disparity map.

9. The system of claim 8, wherein the step of determining the three-dimensional shape of the object further comprises the step of identifying correspondences between the first scale-space representation of the first image and the first scale-space representation of the second image.

10. The system of claim 8, wherein the processor further performs the step of determining the three-dimensional shape of the object further comprises the step of generating feature vectors for the disparity map.

11. The system of claim 10, wherein the feature vectors comprise at least one of the intensities, gradient magnitudes, and continuous orientations of a pixel.

12. The system of claim 10, wherein the processor further performs the step of identifying best matched feature vectors associated with a pair of regions in the first and second images in scale space.

13. The system of claim 8, wherein the step of determining the three-dimensional shape of the object further comprises the step of fusing a pair of disparity maps at each scale and creating a topography of the object.

14. The system of claim 8, wherein the step of determining the three-dimensional shape of the object further comprises the step of wrapping one of the first image and the second image around the topography encoded in the disparity map.

15. A method for determining the three-dimensional shape of an object, comprising:
receiving a plurality of images of an object, each image comprising a first scale;
identifying disparities between regions of each image, the disparities being represented in a first disparity map;
changing the scale of each of the images to a second scale;
generating, from the first disparity map, a second disparity map at the second scale;
generating feature vectors for the first disparity map and the second disparity map; and
identifying the depth of features of the object based on the feature vectors.

16. The method of claim 15, wherein the step of identifying the depth of features further comprises the step of determining the similarity between feature vectors.

17. The method of claim 16, wherein determining the similarity between feature vectors comprises comparing pixel vectors of candidate correspondences.

18. The method of claim 17, wherein the feature vectors comprise at least one of the intensities, gradient magnitudes, and continuous orientations of a pixel.

19. The method of claim 15, wherein the plurality of images are stereo images.

20. The method of claim 15, wherein the plurality of images are color stereo images.

21. The method of claim 15, wherein depth of object features are displayed as a disparity map.

22. The method of claim 15, wherein depth of multiple objects is analyzed with principal component analysis for principal shapes.
